(19) United States
(12) Patent Application Publication
(10) Pub. No.: US 2003/0108163 A1
(43) Pub. Date: Jun. 12, 2003

(54) Origin device based caller identification

(75) Inventors: Michael Wayne Brown, Georgetown, TX (US); Joseph Herbert McIntyre, Austin, TX (US); Michael A. Paolini, Austin, TX (US); James Mark Weaver, Austin, TX (US); Scott Lee Winters, Austin, TX (US)

Correspondence Address: BIGGERS & OHANIAN PLLC, 5 SCARIET RIDGE, AUSTIN, TX, 78737, US

(73) Assignee: INTERNATIONAL BUSINESS MACHINES CORPORATION, ARMONK, NY (US)

(21) Appl. No.: 10/015,381

(22) Filed: Dec. 12, 2001

(51) Int. Cl. H04M 1/64

(52) U.S. Cl. 379/88.01

(57) ABSTRACT

A method, system, and program for origin device initiated caller identification are provided. A voice utterance is detected at an origin device. A caller identity associated with the voice utterance is identified at the origin device, such that the caller identity is transmittable as an authenticated identity of the caller for a call. An intermediary device receives the caller identity with a call request and specifies services available to the caller according to a caller service profile associated with the caller identity.

### CROSS-REFERENCE TO RELATED APPLICATIONS

The present application is related to the following co-pending applications:

(1) U.S. patent application Ser. No. ______ (Attorney Docket No. AUS920010819US1);

(2) U.S. patent application Ser. No. ______ (Attorney Docket No. AUS920010820US1);

(3) U.S. patent application Ser. No. ______ (Attorney Docket No. AUS920010821US1);

(4) U.S. patent application Ser. No. ______ (Attorney Docket No. AUS920010822US1); and

(5) U.S. patent application Ser. No. ______ (Attorney Docket No. AUS920010823US1).

### BACKGROUND OF THE INVENTION

1. Technical Field

The present invention relates in general to telecommunications and, in particular, to voice identification. Still more particularly, the present invention relates to initiating authentication of the identity of a caller at an origin device.

2. Description of the Related Art

Telephone service has created communication channels worldwide, and those channels continue to expand with the advent of cellular and other wireless services. A person can simply take a telephone off-hook and dial a destination number or press a send button and be connected to a telephone line around the world.

Today, the public switching telephone network (PSTN), wireless networks, and private networks telephone services are based on the identification of the wireless telephone or wireline that a calling party uses. Services are personalized according to wireless telephone or wireline telephone number, where services associated with one telephone number are not accessible for another telephone number assigned to the same subscriber. For example, there is typically a first set of service features and billing options assigned to a home line number, a second set of service features and billing options assigned to an office line number, and a third set of service features and billing options assigned to a cellular telephone number. The networks process calls to and from each of these different subscriber telephones based on a separate telephone number.

A problem arises when a caller needs to access a service provided to one telephone number from another telephone number. Further, a problem arises when two or more persons utilize a single line, but each prefers different sets of service options.

One of the services provided by many networks is caller identification. However, caller identification (caller ID) is limited to identification of the wireline or wireless telephone number and the name of the subscriber of a service. Where multiple people share a single line, only the name of the person who establishes a service (the line subscriber) is displayed as the caller ID, often causing confusion about who is actually calling.

Another problem with caller identification is that a caller's phone number is revealed, in cases where the caller does not want a number revealed. Therefore, another service provided by many networks is caller ID blocking. Caller ID blocking service blocks a caller ID of the line from which a call is made from passing to a device receiving a call. Telemarketing companies and other solicitation callers are among those who often block a caller ID.

Therefore, in view of the foregoing, it would be advantageous to provide a method, system, and program for identifying a call according to the identity of caller, rather than the number for the wireline or wireless service from which a call is made. In addition, it would be advantageous to provide a method, system, and program for specifying services available to a caller at any telephony device, rather than just those devices for which the caller is a subscriber.

### SUMMARY OF THE INVENTION

In view of the foregoing, it is therefore an object of the present invention to provide an improved telecommunications system.

It is another object of the present invention to provide a method, system and program for improved voice identification.

It is yet another object of the present invention to provide a method, system and program for initiating authentication of the identity of a caller at an origin device.

According to one aspect of the present invention, a voice utterance is detected at an origin device. A caller identity associated with the voice utterance is identified at the origin device, such that the caller identity is transmittable as an authenticated identity of the caller for a call.

According to another aspect of the present invention, a call request is received at an intermediary device, with an authenticated caller identity from an origin device. A caller profile for the authenticated caller identity is retrieved. A selection of services from among multiple available services are offered for the call request according to the caller profile.

All objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 depicts a block diagram of a network environment in which the present invention may be implemented;

FIG. 2 illustrates a block diagram of the flow of a voice identifier authenticated by an origin device in accordance with the method, system, and program of the present invention;

FIG. 3 depicts a block diagram of the flow of a voice identifier authenticated by a third party device accessible from an origin device in accordance with the method, system, and program of the present invention;

FIG. 4 illustrates a flow diagram of a signal flow and processing where an origin device authenticates a caller identity in accordance with the method, system, and program of the present invention; and

FIG. 5 depicts a flow diagram of a signal flow and processing where a third party system is accessed by an origin device to authenticate a caller identity in accordance with the method, system, and program of the present invention.

### DETAILED DESCRIPTION OF THE PREFERRED EMBODIMENT

A method, system, and program for origin device initiated caller identification are provided. By authenticating a caller identity at an origin device, the caller identity may be transferred from the origin device to an intermediary device and destination device. The caller identity identifies the caller, rather than the line from which a call is made. An intermediary device may then utilize the caller identity to specify services available for a call, such that telephone lines are not limited to the services selected by the line subscriber. Further, a destination device may display the caller identity, such that the callee is notified of who is placing a call.

One advantage of origin device initiated caller identification includes performing caller identity authentication without requiring use of intermediary network resources. Another advantage of origin device initiated caller identification includes maintaining voice samples of callers at the origin device, rather than releasing the voice samples to an intermediary network.

Where needed, a third party server may be accessed by the origin device to aid in caller identity authentication. Authentication by a third party server allows the caller authenticated identity to be verified by an external source without use of intermediary network resources. In addition, a third party server may store voice samples independent of the origin devices, but in a trusted manner.

While in the present invention, authentication of a caller identity is described with emphasis placed on voice authentication, other methods of caller identity authentication may also be performed. Voice samples utilized for voice authentication are just one of multiple types of biometric sampling. For example, a caller may locally provide an eye scan, a fingerprint, and other biophysical identifiers that are transmitted within or outside the trusted network to authenticate the identity of the caller. Alternatively, keypad entries, such as a pin code, account number, password, or other secure transaction key may be entered by a caller and utilized to authenticate the identity of the caller.

In addition, while in the present invention, authentication of a caller identity is described with emphasis upon performing authentication at the beginning of a call, authentication of a caller identity may be performed continuously throughout a call, at selected points throughout a call, and after a call. Selected points where authentication may be performed include when an additional phone pick-up is detected, when a new voice is detected at the origin device, when a call is transferred from one telephone device to another, and other routing of a call that may result in a new caller or in a call being recorded.

Further, while the present invention is described with emphasis upon a caller identity authentication being made for a call to continue, a call may also continue without caller identity authentication. However, where a caller is not identifiable, it may be advantageous to automatically log that the caller lacks proper identification and automatically record calls that lack proper caller identification.

For purposes of the present invention, telephony devices are termed origin devices when utilized for origination of a call to an intermediary device and are termed destination devices when utilized for receipt of a call from an intermediary device. Subscribers to a call are termed callers when originating a call and are termed callees when receiving a call. Callers and callees may or may not be line subscribers to the particular telephony device utilized.

In the following description, for the purposes of explanation, numerous specific details are set forth to provide a thorough understanding of the present invention. It will be apparent, however, to one skilled in the art that the present invention may be practiced without these specific details. In other instances, well-known structures and devices are shown in block diagram form to avoid unnecessarily obscuring the present invention.

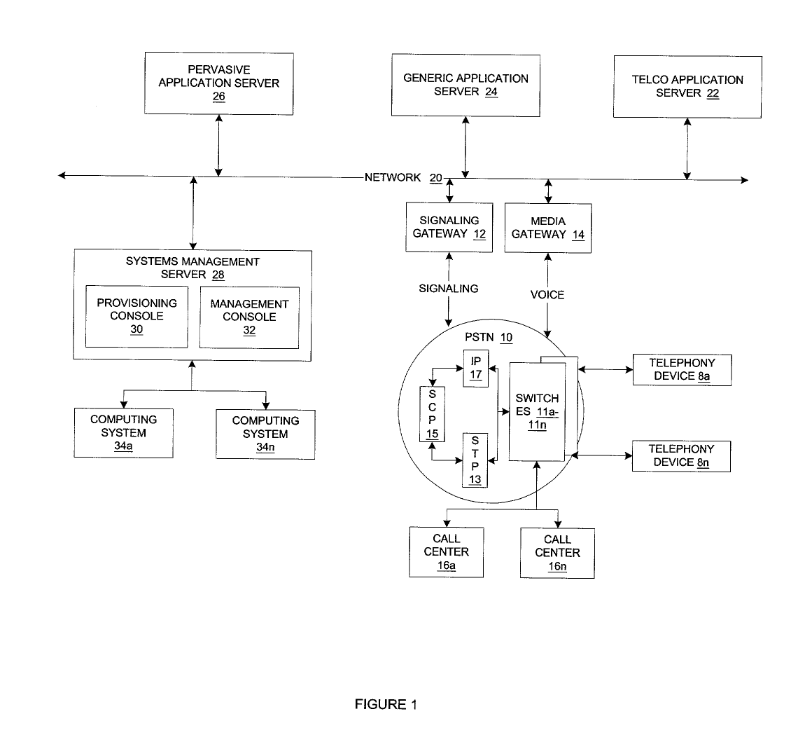

With reference now to the figures, and, in particular, with reference now to FIG. 1, there is depicted a block diagram of a network environment in which the present invention may be implemented. While the present invention is described with reference to one type of network environment, it will be understood by one with skill in the art that the present invention may be implemented in alternate types of network environments.

### General Network Environment

First, the network environment incorporates a Public Switching Telephone Network (PSTN) 10. As is known in the art the core of PSTN 10 may include multiple telephone networks, each owned by one of multiple independent service providers. Each telephone line is carried by an independent service provider within PSTN 10 and is typically assigned to at least one subscriber.

Switching of a call within an independent service provider's telephone network is considered trusted movement within a trusted network because the call remains within the company's telephone network infrastructure. However, calls may be transferred from one service provider's telephone network to another service provider's telephone network in generally trusted movement. Generally, service providers are in competition with one another and therefore there is general trust in transferring a call, but not trust in sharing of subscriber information beyond a subscriber number and name from one service provider to the next without security features or other arrangements.

Advantageously, each telephone network within PSTN 10 may access a data network functioning as an extension to PSTN 10 via an Intranet. Data networks may include, for example, subscriber profiles, billing information, and preferences that are utilized by a service provider to specialize services. Transfer of information between a service provider's data network and telephone network is trusted movement in sharing of information.

Further, each telephone network within PSTN 10 may access server systems external to PSTN 10 in the Internet Protocol over the Internet or an Intranet. Such external server systems may include an enterprise server, an Internet service provider (ISP), an access service provider (ASP), a personal computer, and other computing systems that are accessible via a network. In the present embodiment, transfer of information between PSTN 10 and server systems accessible via network 20 is totally untrusted and therefore may require authentication and additional security.

In the present invention, network 20 may comprise a private network, Intranet, or a public Internet Protocol network. Specifically, telco application server 22, generic application server 24, pervasive application server 26, and systems management server 28 represent server systems external to PSTN 10 that may be accessed by PSTN 10 over network 20.

In particular, telco application server 22 preferably includes multiple telco specific service applications for providing services to calls transferred to a server external to PSTN 10. In particular, a call may be transferred from PSTN 10 to telco application server 22 to receive at least one service and then the call is transferred back to PSTN 10. Such services may also be provided to calls within PSTN 10, however placing such services at a third party such as telco application server 22, is advantageous because adding services and information to PSTN 10 is time consuming and costly when compared with the time and cost of adding the services through telco application server 22.

In accord with an advantage of the present invention, as will be further described, the identity of both the caller and the callee may be authenticated by one of telephony devices 8a-8n, PSTN 10, or by telco application server 22. By authenticating the actual identity of the person making a phone call and the person receiving the phone call, rather than the identification of a device from which a call is made and received, an enhanced specialization of services to subscribers may be performed.

An authentication service within telco application server 22 may include identification and verification of the identity of a caller and/or callee of a particular call. Such a service may require that subscribers provide voice samples when setting up a subscription. The stored voice samples may then be compared against voice samples received for a particular call in order to authenticate the identity of a current caller or callee of the particular call.

Generic application server 24 preferably accesses independent server systems that provide services. For example, a messaging server, a financial server, an Internal Revenue Service (IRS) server, and database management system (DBMS) server may be accessed in HTTP via network 20. Each of these servers may include a telco service application that requires authentication of the subscriber before access is granted. For example, a financial server may provide a telco service application that allows an authenticated subscriber to access current financial records and request stock quotes from the financial server.

Pervasive application server 26 manages services for wirelessly networked devices. In particular, pervasive application server 26 preferably handles distribution of wireless packets of voice and data to wirelessly networked devices utilizing a standard such as short messaging service (SMS) messaging or other 3G standards.

Systems management server 28 manages subscriber personalization via the web. In particular, systems management server 28 includes browser technology that includes a provisioning console 30 for establishing a subscriber profile and a management console 32 for managing and updating the subscriber profile. A subscriber preferably accesses the consoles of systems management server 28 via the Internet utilizing a computing system, such as computing systems 34a-34n.

The subscriber profile may be accessed at systems management server 28 by other external servers and PSTN 10 via network 20. In addition, a local copy of a subscriber profile updated in systems management server 28 may be stored within a particular service provider's data network or telephone network. Each service provider may specify the types of preferences and other information included within a subscriber profile.

In particular, a subscriber may provide a voice imprint when establishing a subscriber profile through provisioning console 30. Other types of authentication information may also be provided including, but not limited to, a password, an eye scan, a smart card ID, and other security devices. In addition, a subscriber may designate billing preferences, shopping preferences, buddy list preferences, and other preferences that enable specialized service to the subscriber when the subscriber's identity is authenticated from the voice imprint or other identification.

Advantageously, a management agent is built into each external server to monitor the services provided by each server according to the authenticated subscriber receiving the services. By monitoring service output according to subscriber, the subscriber may then be billed according to each use of a service.

PSTN 10 preferably includes both voice and data signaling networks that interface with network 20 via gateways. Each of the gateways acts as a switch between PSTN 10 and network 20 that may compress a signal, convert the signal into Internet Protocol (other protocol) packets, and route the packets through network to the appropriate server.

In particular, the voice network interfaces with network 20 through media gateway 14 which supports multiple protocol gateways including, but not limited to, SIP. SIP is a signaling protocol for Internet conferencing, telephony, presence, events notification and instant messaging.

In addition, in particular, the data signaling network interfaces with network 20 through signaling gateway 12 which supports multiple protocol gateways including, but not limited to, parlay protocol gateways and SS7 protocol gateways. Internet servers, such as telco application server 22 may include protocol agents that are enabled to interact with multiple protocols encapsulated in Internet Protocol packets including, but not limited to, SS7 protocol, parlay protocol, and SIP.

### Identity Authentication and Call Control

Looking into PSTN 10, a telephone network typically includes multiple switches, such as central office switches 11a-11n, that originate, terminate, or tandem calls. Central office switches 11a-11n utilize voice trunks for transferring voice communications and signaling links for transferring signals between signaling points.

Between signaling points, one central office switch sends signaling messages to other central office switches via signaling links to setup, manage, and release voice circuits required to complete a call. In addition, between signaling points, central office switches 11a-11n query service control points (SCPs) 15 to determine how to route a call. SCPs 15 send a response to the originating central office switch containing the routing number(s) associated with the dialed number.

SCPs 15 may be general purpose computers storing databases of call processing information. While in the present embodiment SCPs 15 are depicted locally within PSTN 10, in alternate embodiments SCPs 15 may be part of an extended network accessible to PSTN 10 via a network.

One of the functions performed by SCPs 15 is processing calls to and from various subscribers. For example, an SCP may store a record of the services purchased by a subscriber, such as a privacy service. When a call is made to the subscriber, the SCP provides record of the privacy service to initiate an announcement to a caller to identify themself to the subscriber with the privacy service who is being called. According to an advantage of the invention, authentication of the subscriber receiving the call may be required before the privacy service is initiated for that subscriber.

In particular, network traffic between signaling points may be routed via a packet switch called an service transfer point (STP) 13. STP 13 routes each incoming message to an outgoing signaling link based on routing information. Further, in particular, the signaling network may utilize an SS7 network implementing SS7 protocol.

Central office switches 11a-11n may also send voice and signaling messages to intelligent peripherals (IP) 17 via voice trunks and signaling channels. IP 17 provides enhanced announcements, enhanced digit collection, and enhanced speech recognition capabilities.

According to an advantage of the present invention, the identity of a caller is authenticated according to voice authentication. Voice authentication is preferably performed by first identifying a subscriber by matching the name or other identifier spoken with a subscriber name or identifier. Next, voice authentication requires verifying that the voice audio signal matches that of the identified subscriber. However, in alternate embodiments, the identity of a subscriber may be authenticated according to passwords, eye scans, encryption, and other biometric and keyed entries.

In particular, to perform subscriber authentication of audio signals received from callers, IP 17 may include storage for subscriber specific templates or voice feature information, for use in authenticating subscribers based on speech. If a subscriber specific template is not stored on a local IP 17, then a remote IP containing the subscriber specific template may be accessed via a network. In addition, local IP 17 may access systems management server 28 or another repository for voice imprints to access the subscriber specific template.

Where IP 17 authenticates the identity of a caller (e.g. the subscriber placing a call), a voice identifier (VID) representing the authenticated caller identity is transferred as a signal for identifying the caller. In addition, where IP 17 authenticates the identity of a callee (e.g. the subscriber receiving a call), a reverse VID (RVID) including the callee identity is transferred as a signal for identifying the callee.

Advantageously, VIDs indicate through text, voice, or video the identity of a caller. For example, a caller's name may be transferred as the identity of a caller. Alternatively, a video clip stored with the subscriber template may be transferred as the identity of a caller. Additionally, VIDs may indicate the identity of the device utilized by a caller to provide context for a call. Further, VIDs may indicate which system or systems have authenticated the caller identity.

After a VID and/or RVID are determined by IP 17, IP 17 and SCP 15 may communicate to designate which services are available according to VID and RVID. Advantageously, by designating services according to a VID and/or RVID, subscribers are provided with services and billed for those services independent of the devices utilized by subscribers. In particular, a 1129 protocol or other protocol may be utilized to enable signal communications between IP 17 and SCPs 15. In addition, as previously described, caller authentication to determine VIDs and RVIDs may be performed by a third party, such as telco application server 22.

An origin telephony device or destination telephony device may also determine a VID and/or RVID for the caller and/or callee of a call. In particular, telephony devices 8a-8n and call centers 16a-16n may function as origin and designation telephony devices. Each of the telephony devices may include a database of voice templates that may be utilized to authenticate the identity of a caller or callee. In addition, each of the telephony devices may access a third party, such as telco application server 22, to authenticate the identity of the caller or callee. In either case, the telephony device transmits a VID and/or RVID with a call to PSTN 10.

Telephony devices 8a-8n may include, but are not limited to wireline devices, wireless devices, pervasive device equipped with telephony features, a network computer, a facsimile, a modem, and other devices enabled for network communication. Advantageously, as previously described, a voice authentication functioning device may be included in each of telephony devices 8a-8n.

However, in addition to authentication according to voice identification and recognition, telephony devices 8a-8n may be equipped to receive other biometric type input. For example, telephony devices 8a-8n include an eye print scanner, a fingerprint scanner, and other devices that detect individual human characteristics. Preferably, telephony devices 8a-8n may receive these other types of biometric input and compare other types of biometric input with previous recorded samples to determine the identity of a caller.

In addition, telephony devices 8a-8n may each incorporate a display that provides a visual output of a VID or RVID. Alternatively, such a display may be provided in a separate device connected to the line in parallel to telephones 8a-8n. According to one advantage of the present invention, the identity of the actual caller or actual callee are output to a display in association with a call. In addition, other context information about the caller including, but not limited to, the device from which the call originates or is answered, ratings for a caller or callee, and other context information may be output to a display in association with a call.

Telephony devices 8a-8n are communicatively connected to PSTN 10 via wireline, wireless, ISDN, and other communication links. Preferably, connections to telephony devices 8a-8n provide digital transport for two-way voice grade type telephone communications and a channel transporting signaling data messages in both directions between telephony devices 8a-8n and PSTN 10.

In addition to telephony devices 8a-8n, advanced telephone systems, such as call centers 16a-16n, may be communicatively connected to PSTN 10 via wireline, wireless, ISDN and other communication links. Call centers 16a-16n may include PBX systems, hold queue systems, private network systems, and other systems that are implemented to handle distribution of calls to multiple representatives or agents.

Returning to central office switches 11a-11n, typically, one central office switch exists for each exchange or area served by the NXX digits of an NXX-XXXX (seven digit) telephone number or the three digits following the area code digits (NPA) in a ten-digit telephone number. The service provider owning a central office switch also assigns a telephone number to each line connected to each of central office switches 11a-11n. The assigned telephone number includes the area code (NPA) and exchange code (NXX) for the serving central office and four unique digits (XXXX).

Central office switches 11a-11n utilize office equipment (OE) numbers to identify specific equipment, such as physical links or circuit connections. For example, a subscriber's line might terminate on a pair of terminals on the main distribution frame of one of central office switches 11a-11n. The switch identifies the terminals, and therefore a particular line, by an OE number assigned to that terminal pair. For a variety of reasons, a service provider may assign different telephone numbers to the one line at the same or different times. For example, a local carrier may change the telephone number because a subscriber sells a house and a new subscriber moves in and receives a new number. However, the OE number for the terminals and thus the line itself remains the same.

On a normal call, a central office switch will detect an off-hook condition on a line and provide a dial tone. The switch identifies the line by the OE number. The central office switch retrieves profile information corresponding to the OE number and off-hook line. Then, the central office switch receives the dialed digits from the off-hook line terminal and routes the call. The central office switch may route the call over trunks and possibly through one or more central office switches to the central office switch that serves the called party's station or line. The switch terminating a call to a destination will also utilize profile information relating to the destination, for example to forward the call if appropriate, to apply distinctive ringing, etc.

In the present invention, when a central office switch detects an off-hook condition on a line, the central office switch will then determine if a VID signal is transferred from the off-hook telephony device. If a VID is transferred, then a query is made to SCP 15 according to the VID for any services specified for the authenticated subscriber. Alternatively, a query may be transferred via network 20 to an external server, such as system management server 28, to determine the services specified for the caller. The central office switch will then receive the dialed digits from the off-hook line terminal and route the call, providing services according to those preferred by the authenticated subscriber.

In addition, an RVID may be provided in the present invention to authenticate the identity of a callee receiving the call. When a call is answered, the call is transferred back to an IP or telco application server 22 to authenticate the identity of the callee answering the call.

As another alternative to dialed digits from the off-hook line terminal, a caller may utilize a voice calling function of a telephony device for indicating how the call should be routed. For example, a caller may say the name of a preferred callee. The device or IP 17 may determine a person within the caller's calling list that matches the voiced name. The matching person's digits are then utilized to route the call.

### VID Authentication Context

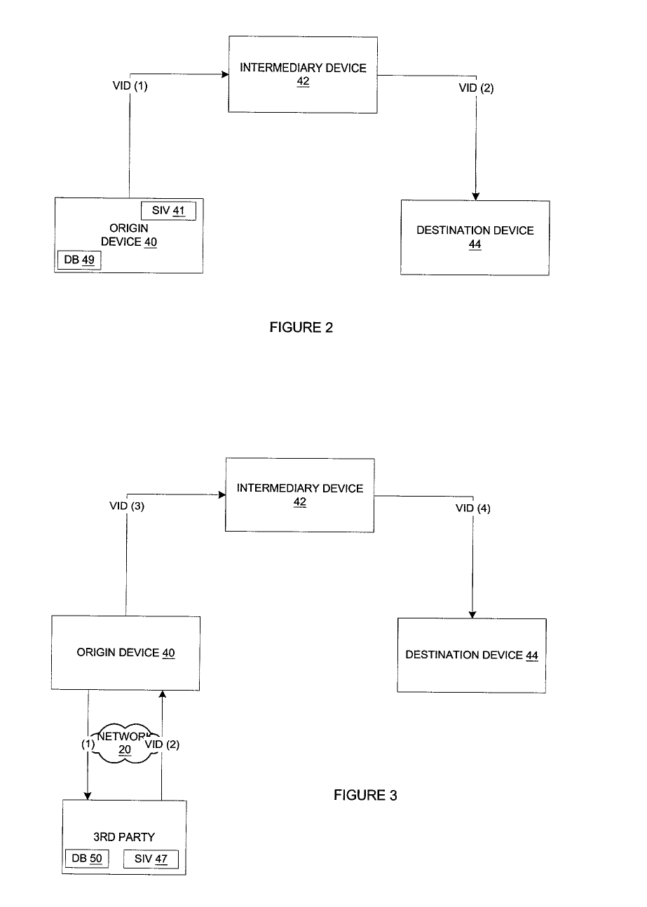

Referring now to FIG. 2, there is illustrated a block diagram of the flow of a voice identifier authenticated by an origin device in accordance with the method, system, and program of the present invention.

As depicted, an origin device 40 authenticates a VID for a current caller. In particular, origin device 40 may include a caller telephony device, as previously described. However, origin device 40 may also include a PBX, call center or other private switching system that manage multiple telephony devices. Moreover, origin device 40 may include network servers, feature servers, and other systems which provide call origination.

A service identification/verification (SIV) 41 feature within origin device 40 may determine the identity of a caller and authenticate that identity by comparing a voice utterance made by a caller with a database of voice samples stored in a voice sample database 49 within origin device 40. The voice utterance may include, for example, the caller's name and the caller's service provider. In addition, SIV 41 may continue to monitor and authenticate the caller identity throughout the call, at a periodic rate and/or in response to triggers.

A VID authenticated by origin device 40 is preferably transmitted to an intermediary device 42. In particular, intermediary device 42 may include a PSTN switching network. However, intermediary device 42 may also include a PBX, call center or other private switching system. Moreover, intermediary device 42 may include network servers, telco application servers, Websphere7 servers (Websphere7 is a registered trademark of International Business Machines, Inc.), and other systems which provide call processing.

SIV feature 41 may also filter the VID according to recipient prior to transfer to intermediary device 42. The VID is preferably filtered according to caller preferences, including blocking preferences and content selection preferences. For example, a caller may select to block the callee from receiving the VID. In another example, the caller may select to limit the information in the VID to the caller's last name. In addition, intermediary device 42 and destination device 44 may filter and record the VID.

Intermediary device 42 may utilize the VID to determine services available to a caller. Further, intermediary device 42 may utilize the VID to access a caller profile and other contextual information about a caller. Moreover, intermediary device 42 may prompt a caller to provide a voice utterance that may be analyzed to further authenticated the VID of the caller.

Intermediary device 42 connects origin device 40 with a destination device 44. In particular, destination device 44 may include a callee telephony device, as previously described. However, destination device 44 may also include a PBX, call center, or other private switching system that manages multiple telephony devices. Moreover, destination device 44 may include network servers, feature servers, client side devices, and other systems which provide call receipt.

The authenticated VID is preferably transferred from intermediary device 42 to destination device 44 with a call. Destination device 44 advantageously includes a display device or other output interface for output of the authenticated VID to the callee, such that the identity of the caller of an incoming call is provided to the callee.

In the present invention, a VID preferably authenticates the identity of a caller. However, it is advantageous that the VID also include other information that provide a context for a call. For example, the GPS location or time zone of the caller location, the device from which the call is placed, the subject matter of the call, and whether the caller is calling on behalf of another, may be included in a VID. Further, the identity of the device that performed the caller authentication may be included in a VID.

A VID may be transferred in multiple protocols, including, but not limited to, Interface Definition Language (IDL). A VID may include a range of information, where each type of information may be tagged or identified in some other manner. For example, the following tagged VID may be transmitted to represent an authenticated identity of a caller:

[name] Jon Smith

[device] Jane Doe's cell phone

[location] Central Time zone

[subject] Project A

[authenticated by] Jane Doe's cell phone

Destination device 44 may output all the information included in a VID or a selection of the information. For example, for the tagged VID described above, destination device 44 may output the following to an input/output interface associated with destination device 44:

AIncoming call from Jon Smith, using Jane Doe's cell phone, in reference to Project A@

In addition, destination device 44 may interpret the information included in a VID. For example, for the tagged VID described above, destination device 44 may interpret the location and output the following:

AIt is currently 4:00 PM at Jon Smith's location@

Further, destination device 44 may perform other functions with a VID. For example, destination device 44 may translate the VID into a particular language. In addition, destination device 44 may request additional information for a VID from a third party server.

With reference now to FIG. 3, there is depicted a block diagram of the flow of a voice identifier authenticated by a third party device accessible from an origin device in accordance with the method, system, and program of the present invention.

As illustrated, origin device 40 may access a third party device 46 with a request for VID authentication. Third party device 46 may include a telco application server, accessible via a network, that performs caller authentication. However, third party device 46 may also be a stand alone system or a server connected to a PBX, a private switching system, or a service provider switching system.

Third party device 46 may include a SIV 47 feature that receives a voice utterance from origin device 40 and authenticates an identity of a caller associated with the voice utterance by comparing the voice utterance with a database 50 of voice samples stored at third party device 46. Third party device 46 then returns an VID containing the identity of the caller. Origin device 40 may add additional information to the VID to provide context for the call.

Alternatively, origin device 40 may access a database of voice samples stored at third party device 46. Where origin device 40 requests voice samples from third party device 46, origin device 40 may, for example, request a selection of voice samples for a name identified from a voice utterance. Origin device 40 then authenticates a VID for the caller according to the retrieved selection of voice samples.

Communications between origin device 40 and third party device 46 may be facilitated by intermediary device 42. In addition, communications between origin device 40 and third party device 46 may be facilitated by network 20, such as the Internet, an Intranet, or a private networking service.

SIV 47 may implement levels of security in communications with origin device 40. For example, a secure channel utilizing a secure socket layer may be implemented. In addition, other encryption techniques may be implemented for transfer of information.

In an example, a voice utterance provided by a caller may include a name and a service provider from which the caller receives service. Origin device 40 may then contact the third party service provider device 46 and request either an authentication of the voice utterance or voice samples for a name identified from the voice utterance. The third party service provider advantageous stores voice samples for each customer, such that identity authentication may be performed.

In another example, advantageously, voice sample database 49 within origin device 40 may include numerous voice samples of the callers who typically utilize origin device 40. For example, numerous voice samples for members of a household may be stored at an origin device 40 for a household. However, where a caller not included in voice sample database 49 utilizes origin device 40, the identity of the caller is preferably authenticated through the aid of third party device 46. For example, where a friend utilizes a telephony device in the household, third party device 46 is preferably accessed to authenticate the identity of the caller.

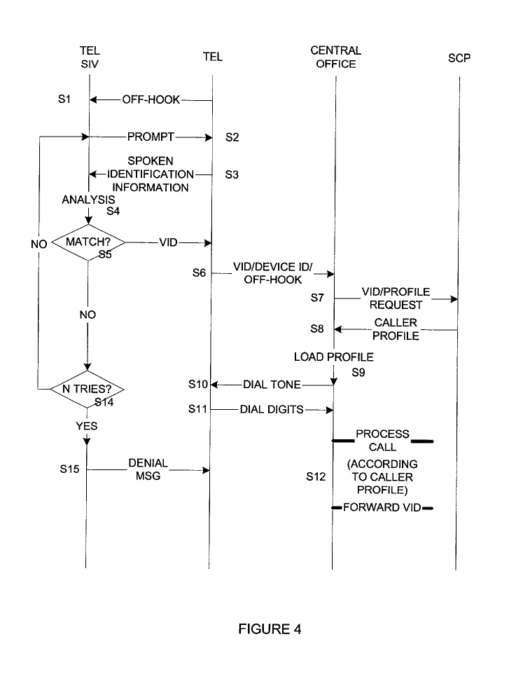

Referring now to FIG. 4, there is illustrated a flow diagram of a signal flow and processing where an origin device authenticates a caller identity in accordance with the method, system, and program of the present invention. A standard telephone device is assumed for the Atel@ origin device in the present example. However, a similar signal flow may be applied to other types of origin devices.

The caller lifts a handset creating an off-hook state in the origin device and a corresponding signal within the origin device to a service identification/verification (SIV) feature within the origin device (step S1). In response to the off-hook signal received at the SIV, the SIV initiates an identity authentication process for authenticating the identity of the current caller. First, the SIV provides a prompting instruction to the caller to provide specific identifying information (step S2). It should be mentioned that although the SIV could passively monitor any speech that the caller may utter, it is advantageous to specifically prompt the caller. For example, the SIV may play an audio prompt message asking the caller to APlease say your full name.@ In addition, the prompt may request other identifying information such as a service provider and subject of the call, for example. Further, the central office may trigger a SIV initiation to an IP at other times during a call. The spoken identification information is then received at the origin device and transferred to the SIV (step S3).

Analysis is performed on the spoken identification information to determine a name of a caller and extract speech characteristics information (step S4). A voice template or other voice pattern information may be stored in the origin device according to a caller identity. In addition, voice template information may be stored at a third party server accessible to the origin device. Preferably, the SIV compares the extracted speech information to the stored pattern information, to identify and authenticate the particular caller. If there is a match between the extracted speech information and the stored pattern information, then a VID signal containing the authenticated identity of the caller is then distributable among multiple devices (step S5).

In addition to authenticating the identity of the caller placing a call, the identity of the device utilized to place the call may be included in a VID. Each origin device may include an identification number that is attached to the VID of a call at the origin device. Alternatively, where a single OE line includes multiple outlets, the device at each outlet may be identified according to the location of the outlet.

Once a VID is returned, then an off-hook signal or change in state of the line is sent to the central office with the VID transferred along the data signal line (step S6). In response to detecting an off-hook signal at the central office, call processing commences. Specifically, the central office assigns a register to the call and loads information associated with the OE for the off-hook line into the assigned register. In particular, while in the present embodiment the VID and the off-hook signal are transferred concurrently, in alternate embodiments, the off-hook signal to the central office may be detected concurrently with the off-hook signal detected by the origin device SIV.

Receipt of the VID signal at the central office may trigger sending the VID signal to the SCP with a request for a profile (step S7). The SCP may store a profile of telephone services available to a caller according to VID from the PSTN, a telco application server and a generic application server. In addition, the SCP may store other preference and personal information about each caller according to VID. Further, in lieu of, or in addition to the information stored at the SCP, a request may be extended from the PSTN to other servers storing information about a caller according to caller profile, depending on the services to be provided to a caller.

The caller profile for the VID is returned via a data signal to the central office (step S8). The central office then loads profile the services associated with the profile for access by the caller (step S9). The combined caller profile information preferably includes caller specific service information available to the caller from the PSTN or from a telco application server. In addition, the caller profile information may include billing information, enabling billing the caller for each service.

Next, a dial tone is extended to the origin device from the central office (step S10). While in the present example the dial tone is not extended to the origin device until after a profile is loaded according to a VID, in alternate embodiments, a dial tone may be extended to the origin device after a line subscriber profile for the telephone line is loaded. Then, the individual caller profile accessed according to the VID may replace or supplement the line subscriber profile for the telephone line.

A caller may then input keypad entries to dial digits or may utilize a voice dial feature if available (step S11). The dialed digits are loaded into the assigned register within the central office switch. The central office utilizes the dialed digits and the caller profile to process the call (step S12). In processing the call, the caller VID is preferably forwarded to the destination device for output. In particular, information within the caller VID may be output at the destination device according to preferences designated at the destination device.

The importance of forwarding the caller VID to the destination device is that the callee receives the identity of the caller, not just the line number from which the call is received. Output of a caller VID, including a caller name, device identification, geographic context, and other information, is more advantageous than a typical caller ID that indicates the line number and person billed for the line number because the actual caller is identified, but the actual line number may be blocked from the callee.

If there is not a match of the extracted speech information with the voice templates, then a determination is made as to whether a caller has made more than n tries to speak identification information that has not matched (step S14). If the caller has not made more than n tries, then a prompt is output to the caller to provide another spoken utterance. If the caller has made more than n tries, then a denial message is output to the caller (step S15). In addition, instructions for creating a voice template may be provided or an off-hook signal or change in state of the line without an associated VID may be sent to the central office, such that the caller is enabled to place a call utilizing the services associated with the OE of the line.

According to one advantage of the present invention, where an origin device is a PBX system that manages multiple phone lines, the PBX system often assigns an arbitrary number to calls sent out from the PBX system, such that an employee's phone number cannot be captured. It may be advantageous, by the present invention, to provide the identity of a caller from an employer PBX system. However, employers may not want to disclose the voice templates of employees to a third party system. Therefore, the employee voice templates are stored in association with the origin PBX system that manages employee telephones. In addition, the VID that is transmitted from the PBX system may include a VID that is encrypted only for use by the intermediary for providing services to the employee according to the VID. The VID received by the destination device may only include an identification of the company.

It should be noted that with each transfer of a VID, the central office, the SCP, and the origin device may each record and filter the VID. In particular, filtering the VID may require blocking all or portions of the content of the VID.

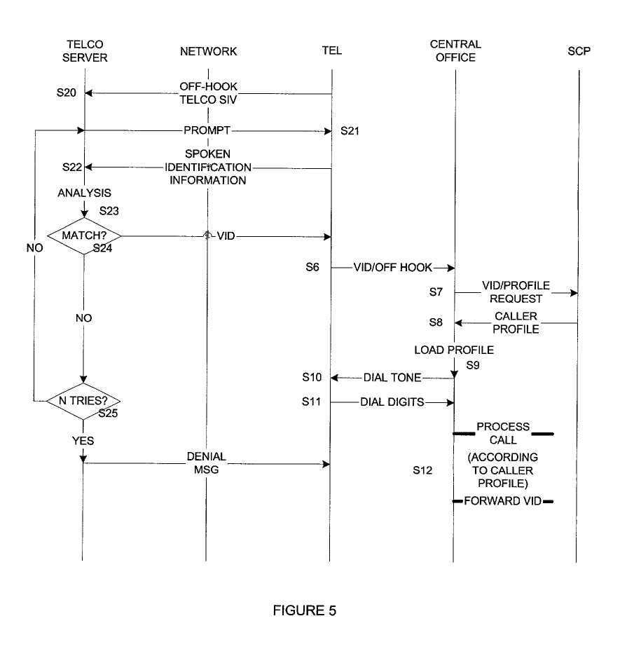

With reference now to FIG. 5, there is depicted a flow diagram of a signal flow and processing where a third party system is accessed by an origin device to authenticate a caller identity in accordance with the method, system, and program of the present invention.

The caller lifts a handset creating an off-hook state in the origin device and a corresponding signal within the origin device requests a network connection to a telco server that performs an identity authentication service (step S20). In particular, the request for a network connection may first transfer to a central office of a switching system that then forwards the call via a network to a telco server. Alternatively, the origin device may also directly access a network, such as the Internet, to connect with the telco server. A secure channel may be established with the request for a network connection.

Next, in response to receiving the off-hook status from the origin device via a network, the telco application server initiates an identity authentication process for authenticating the identity of the current caller. Where the origin device is a wireless telephony device, the off-hook status may be a connection request or other type of signal received at a wireless network server.

First, an authorization service application provides a prompting instruction to the caller to provide specific identifying information (step S21). For example, the authorization service application may play an audio prompt message asking the caller to APlease say your full name.@ In addition, the prompt may request other identifying information such as a service provider and subject of the call, for example. The spoken identification information is then received at the origin device and transferred via the network to the telco application server (step S22).

Analysis is performed on the spoken identification information to determine a name of a caller and extract speech characteristics information (step S23). A voice template or other voice pattern information may be accessible to the telco application server from a local or remote database management system. Preferably, the authorization service application compares the extracted speech information to the stored pattern information, to identify and authenticate the particular caller. If there is a match between the extracted speech information and the stored pattern information, then a VID signal containing the authenticated identity of the caller is then distributable among multiple devices (step S24).

If there is not a match of the extracted speech information with the voice templates, then a determination is made as to whether a caller has made more than n tries to speak identification information that has not matched (step S25). If the caller has not made more than n tries, then a prompt is output to the caller to provide another spoken utterance. If the caller has made more than n tries, then a denial message is output to the caller (step S26). In addition, instructions for creating a voice template may be provided or an off-hook signal or change in state of the line without an associated VID may be sent to the central office, such that the caller is enabled to place a call utilizing the services associated with the OE of the line.

Whether the origin device authenticates a caller identity locally or via a third party system, such as a telco application server, the VID of a caller is utilized to specify services provided to the caller. An advantage of authenticating a caller identity via a third party system is that the VID is authorized by a third party system, rather than an origin system that is not as trusted within the network.

In addition, by authenticating a caller identity via a third party system, an origin device that has a large number of potential callers need not store voice templates for all potential callers. For example, where the intermediary device is a private PBX system and the origin device and destination device are office phones, multiple employees may at any time utilize any of the office phones. Rather than storing voice templates at each phone, each office phone used as an origin device may first access a server of voice templates for authentication of a caller identity. Thus, regardless of the phone that a caller employee uses, the callee employee will receive the identity of the caller, rather than just the extension number from which the caller is calling.

However, knowing the extension number of the call may also be advantageous to a callee because the extension number may provide a valuable context for a call. For example, where a first employee is calling a second employee from a bosses extension, the second employee receives the VID of the first employee plus the extension identifier, and thus is prepared for other possible participants to a conversation.

In the case of an internal business phone system, it may be advantageous to skip the voice prompt step and just detect a caller providing speech identification information. Employees could then just pick up any phone and speak a full name and any other requested information, dial digits, and be connected to a destination device. In addition, where voice dialing is a feature included in an origin device, it may be advantageous to skip the voice prompt step, such that the caller may enter a seamless speech entry, such as AJohn Doe calling Albert Smith@ and the identity of John Doe would be authenticated and the phone number for Albert Smith retrieved and dialed.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

While the invention has been particularly shown and described with reference to a preferred embodiment, it will be understood by those skilled in the art that various changes in form and detail may be made therein without departing from the spirit and scope of the invention.

What is claimed is:

1. A method for identifying a particular caller, said method comprising:
detecting a voice utterance at an origin device;
identifying a caller identity associated with said voice utterance at said origin device, such that said caller identity is transmittable as an authenticated identity of said caller for a call.

2. The method for identifying a particular caller according to claim 1, further comprising:
prompting said caller to provide said voice utterance.

3. The method for identifying a particular caller according to claim 1, further comprising:
prompting said caller to enter an additional input to verify said caller identity.

4. The method for identifying a particular caller according to claim 1, wherein identifying a caller identity further comprises:
extracting speech characteristics from said voice utterance; and
comparing said speech characteristics with a plurality of voice samples stored for identifying a plurality of callers.

5. The method for identifying a particular caller according to claim 1, further comprising:
transmitting said voice utterance to a third party device via a network; and
receiving said caller identity from said third party device.

6. The method for identifying a particular caller according to claim 1, further comprising:
requesting a voice sample for said particular caller from a third party device accessible via a network; and
receiving said voice sample for said particular caller for enabling authenticating of said caller identity.

7. The method for identifying a particular caller according to claim 1, further comprising:
initiating a call from said origin device to an intermediary device; and
forwarding said caller identity with said call initiation to said intermediary device, wherein said intermediary device is enabled to forward said caller identity to a destination device to process said call.

8. The method for identifying a particular caller according to claim 1, wherein said origin device is a call center.

9. The method for identifying a particular caller according to claim 1, wherein said origin device is a private exchange network.

10. The method for identifying a particular caller according to claim 1, wherein said origin device is a telephony device.

11. The method for identifying a particular caller according to claim 1, wherein said caller identity comprises at least one from among a caller name, a caller location, a subject of said call, and a device identification.

12. A system for identifying a particular caller, said system comprising:
an origin telephony device;
means for detecting a voice utterance at said origin telephony device;
means for identifying a caller identity associated with said voice utterance at said origin telephony device, such that said caller identity is transmittable as an authenticated identity of said caller for a call.

13. The system for identifying a particular caller according to claim 12, further comprising:
means for prompting said caller to provide said voice utterance.

14. The system for identifying a particular caller according to claim 12, further comprising:
means for prompting said caller to enter an additional input to verify said caller identity.

15. The system for identifying a particular caller according to claim 12, wherein said means for identifying a caller identity further comprises:
means for extracting speech characteristics from said voice utterance; and
means for comparing said speech characteristics with a plurality of voice samples stored for identifying a plurality of callers.

16. The system for identifying a particular caller according to claim 12, further comprising:
means for transmitting said voice utterance to a third party device via a network; and
means for receiving said caller identity from said third party device.

17. The system for identifying a particular caller according to claim 12, further comprising:
means for requesting a voice sample for said particular caller from a third party device accessible via a network; and
means for receiving said voice sample for said particular caller for enabling authenticating of said caller identity.

18. The system for identifying a particular caller according to claim 12, further comprising:
means for initiating a call from said origin telephony device to an intermediary telephony device; and
means for forwarding said caller identity with said call initiation to said intermediary telephony device, wherein said intermediary telephony device is enabled to forward said caller identity to a destination telephony device in processing said call.

19. The system for identifying a particular caller according to claim 12, wherein said origin telephony device is a call center.

20. The system for identifying a particular caller according to claim 12, wherein said origin telephony device is a private exchange network.

21. The system for identifying a particular caller according to claim 12, wherein said origin device is an individual telephone.

22. The system for identifying a particular caller according to claim 12, wherein said origin device is a computer system communicatively connected to a network enabled for voice communications.

23. The system for identifying a particular caller according to claim 12, wherein said caller identity comprises at least one from among a caller name, a caller location, a subject of said call, and a device identification.

24. A computer program product for identifying a particular caller, said computer program product comprising:
a recording medium;
means, recorded on said recording medium, for detecting a voice utterance at said origin telephony device;
means, recorded on said recording medium, for authenticating a caller identity associated with said voice utterance at said origin telephony device.

25. The computer program product for identifying a particular caller according to claim 24, further comprising:
means, recorded on said recording medium, for prompting said caller to provide said voice utterance.

26. The computer program product for identifying a particular caller according to claim 24, further comprising:
means, recorded on said recording medium, for prompting said caller to enter an additional input to verify said caller identity.

27. The computer program product for identifying a particular caller according to claim 24, further comprising:
means, recorded on said recording medium, for extracting speech characteristics from said voice utterance; and
means, recorded on said recording medium, for comparing said speech characteristics with a plurality of voice samples stored for identifying a plurality of callers.

28. The computer program product for identifying a particular caller according to claim 24, further comprising:
means, recorded on said recording medium, for transmitting said voice utterance to a third party device via a network; and
means, recorded on said recording medium, for receiving said caller identity from said third party device.

29. The computer program product for identifying a particular caller according to claim 24, further comprising:
means, recorded on said recording medium, for requesting a voice sample for said particular caller from a third party device accessible via a network; and
means, recorded on said recording medium, for receiving said voice sample for said particular caller for enabling authenticating of said caller identity.

30. The computer program product for identifying a particular caller according to claim 24, further comprising:
means, recorded on said recording medium, for initiating a call from said origin telephony device to an intermediary telephony device; and
means, recorded on said recording medium, for forwarding said caller identity with said call initiation to said intermediary telephony device, wherein said intermediary telephony device is enabled to forward said caller identity to a destination telephony device in processing said call.

31. A method for specifying telephone services for a particular caller, comprising:
receiving, at an intermediary device, an authenticated caller identity for a call request from an origin device;
retrieving a caller profile for said authenticated caller identity; and
specifying a selection of services from among a plurality of services that are offered for said call request according to said caller profile.

32. The method for specifying telephone services for a particular caller according to claim 31, wherein said authenticated caller identity is authenticated by a voice utterance of said caller.

33. The method for specifying telephone services for a particular caller according to claim 31, wherein retrieving a caller profile further comprises:
retrieving said caller profile from a profile database within said intermediary device.

34. The method for specifying telephone services for a particular caller according to claim 31, wherein retrieving a caller profile further comprises:
retrieving said caller profile from a systems management server.

35. A system for specifying telephone services for a particular caller, comprising:
an intermediary device communicatively connected to a telephone network;
means for receiving, at said intermediary device, an authenticated caller identity for a call request from an origin device;
means for retrieving a caller profile for said authenticated caller identity; and
means for specifying a selection of services from among a plurality of services that are offered for said call request according to said caller profile.

36. The system for specifying telephone services for a particular caller according to claim 35, wherein said authenticated caller identity is authenticated by a voice utterance of said caller.

37. The system for specifying telephone services for a particular caller according to claim 35, wherein retrieving a caller profile further comprises:
means for retrieving said caller profile from a profile database within said intermediary device.

38. The system for specifying telephone services for a particular caller according to claim 35, wherein retrieving a caller profile further comprises:
means for retrieving said caller profile from a systems management server.

39. A computer program product for specifying telephone services for a particular caller, comprising:
a recording medium;
means, recorded on said recording medium, for receiving an authenticated caller identity for a call request from an origin device;
means, recorded on said recording medium, for retrieving a caller profile for said authenticated caller identity; and
means, recorded on said recording medium, for specifying a selection of services from among a plurality of services that are offered for said call request according to said caller profile.

40. The computer program product for specifying telephone services for a particular caller according to claim 39, further comprising:
means, recorded on said recording medium, for retrieving said caller profile from a profile database within said intermediary device.

41. The computer program product for specifying telephone services for a particular caller according to claim 39, further comprising:
means, recorded on said recording medium, for retrieving said caller profile from a systems management server.

42. A method for identifying a caller, said method comprising:
detecting a biometric input at a biometric enabled origin device;
identifying a caller identity associated with said biometric input at said origin device, such that said caller identity is transmittable as an authenticated identity of said caller for a call.

43. The method for identifying a caller according to claim 16, wherein said biometric input comprises at least one from among an eye print, a finger print, a voice input, and a body heat scan.

44. A method for identifying a caller to a call, comprising:
detecting a call request at an origin device;
accessing a third party system enabled to authenticate a caller identity;
receiving a prompting from said third party system to provide a voice utterance;
responsive to detecting a voice utterance at said origin device, transferring said voice utterance to said third party system; and
receiving, from said third party system, an authenticated identity of said caller according to said voice utterance.

45. The method for identifying a caller according to claim 18, wherein accessing a third party system further comprises:
accessing said third party system via a trusted telephone network.

46. The method for identifying a caller according to claim 18, wherein accessing a third party system further comprises:
accessing said third party system via a network comprising at least one of the Internet, an intranet, and a private line.

47. A method for caller identification, comprising:
detecting a call request at an origin device;
detecting a voice utterance at said origin device from a caller;
accessing a third party system for a voice imprint corresponding to said voice utterance;
authenticating an identity of said caller identified in said voice imprint by matching said accessed voice imprint with said voice utterance.
